(19) United States
(12) Patent Application Publication
(10) Pub. No.: US 2026/0249574 A1
(43) Pub. Date: Aug. 27, 2026

(54) SYSTEMS AND METHODS FOR PRODUCING A SPORTS BALL

(71) Applicant: Weststar Consultancy Inc, North York (CA)

(72) Inventor: Ali Hasnain HUSSAIN, North York (CA)

(73) Assignee: Weststar Consultancy Inc, North York (CA)

(21) Appl. No.: 19/561,024

(22) Filed: Mar. 9, 2026

Related U.S. Application Data
(63) Continuation-in-part of application No. 18/619,971, filed on Mar. 28, 2024, now Pat. No. 12,570,058.

(51) Int. Cl. B29D 22/02; B29K 21/00; B29K 675/00

(52) U.S. Cl. CPC B29D 22/02; B29K 2021/003; B29K 2675/00; B29K 2715/003

(57) ABSTRACT

A method for forming a plurality of panels, which may comprise cutting a plurality of Polyurethane (PU) layer cutouts corresponding to a respective shape for each of the plurality of panels from a sheet of PU, placing each of the plurality of PU layer cutouts in a corresponding mold, forming each respective panel in each respective corresponding mold by injecting melted TPE into each of the corresponding molds for thirty to forty seconds, and creating a bladder valve panel by inserting a valve in one of the plurality of created panels. Method may further comprise forming a pre-finalized ball by attaching the plurality of the panels including the bladder valve panel to a bladder and respective edges to each of the plurality of the panels to respective edges of adjacent panels of the plurality of the panels, and placing the pre-finalized sports ball in a mold and applying heat to the pre-finalized sports ball.

### RELATED APPLICATIONS

This Applicant is a Continuation-in-Part of U.S. application Ser. No. 18/619,971, filed Mar. 28, 2024, and entitled “Systems and Methods for Producing a Sports Ball”, which is incorporated herein in its entirety.

### TECHNIAL FIELD

The present disclosure relates generally to a ball and a method for manufacturing a ball. More particularly, and without limitation, the present disclosure relates to structures and methods for manufacturing a sports ball.

### BACKGROUND

Conventional thermos-bonded sports balls with internal bladder have numerous drawbacks including required numerous complicated steps in their manufacturing taking longer time and creating unnecessary wastage during these numerous processes and investment in machinery for every step of manufacturing. Therefore, for increasing manufacturing capacity, there is a need for significantly increasing manpower and cost.

Exemplary embodiments, consistent with the present disclosure, therefore, aim to resolve the aforementioned problems including allowing for the same quality and consistency of balls during usage but allowing for more cost-effective and time effective manufacturing mechanisms, among others.

### SUMMARY

An object of the invention is to provide a new and improved sports ball having a high performance, synthetic leather balls that are of high quality but are manufactured utilizing exemplary approaches, providing high durability while also providing manufacturing cost-efficiency in terms of time and costs.

In an exemplary embodiment, a manufacturing method of a sports ball is provided. Exemplary methods comprise the steps of forming a plurality of panels, which may comprise forming a plurality of cutouts, which may comprise cutting a plurality of Polyurethane (PU) layer cutouts corresponding to a respective shape for each of the plurality of panels from a sheet of PU, placing each of the plurality of PU layer cutouts in a corresponding mold, wherein a shape of the corresponding mold corresponds to a shape of a finalized cutouts, and forming each respective cutout in each respective corresponding mold by injecting melted TPE or TPR (Thermoplastic Rubber) into each of the corresponding molds for thirty to forty seconds. In an exemplary embodiment, an exemplary method may further comprise forming pre-mold cutouts by creating one or more foam indentations on each respective cutout of the plurality of cutouts by removing a part of the foam of each respective cutout of the plurality of cutouts by applying a laser to the foam of each respective cutout, and then forming each respective panel of the plurality of panels by placing each of the pre-mold cutouts in a corresponding secondary mold, wherein a shape of the corresponding secondary mold corresponds to a shape of a finalized panel, the corresponding secondary mold comprising of an upper mold portion and a lower mold portion, the lower mold portion comprising a cavity in a desired shape of a respective panel, the upper mold portion comprising a pressing part corresponding to shape of the cavity, wherein each of the pre-mold cutouts with an end-to-end length more than an end-to-end length of the pressing part, and creating a bladder valve panel by inserting a valve in one of the plurality of created panels.

Exemplary method may further comprise forming a pre-finalized ball by attaching the plurality of the panels including the bladder valve panel to a bladder and respective edges to each of the plurality of the panels to respective edges of adjacent panels of the plurality of the panels, and placing the pre-finalized sports ball in a mold and applying heat to the pre-finalized sports ball.

### BRIEF DESCRIPTION OF THE DRAWINGS

The accompanying drawings, which are incorporated in and constitute a part of this specification, illustrate exemplary embodiments of the present disclosure and, together with the description, serve to explain the principles of the disclosure.

FIG. 1A illustrates an exemplary method for manufacturing a sports ball, consistent with one or more exemplary embodiments of the present disclosure;

FIG. 1B illustrates an exemplary method for forming a plurality of panels, consistent with one or more exemplary embodiments of the present disclosure;

FIG. 1C illustrates another exemplary method for forming a plurality of panels, consistent with one or more exemplary embodiments of the present disclosure;

FIG. 1D illustrates a method for forming a plurality of cutouts, consistent with one or more exemplary embodiments of the present disclosure;

FIG. 1E illustrates a method for forming pre-mold cutouts by creating one or more indentation on each of the respective cutouts by applying a laser to the foam of each respective cutout, consistent with one or more exemplary embodiments of the present disclosure;

FIG. 2 illustrates an exemplary PU Sheet, consistent with one or more exemplary embodiments of the present disclosure;

FIGS. 3A and 3B are illustrations of an exemplary scenario for cutting out a plurality of PU layer cutouts, consistent with one or more exemplary embodiments of the present disclosure;

FIG. 4A illustrates dimensions of cutouts, consistent with one or more exemplary embodiments of the present disclosure;

FIG. 4B illustrates fold lines and dimensions of cutouts, consistent with one or more exemplary embodiments of the present disclosure;

FIGS. 5A and 5B illustrate exemplary molds in top and perspective views respectively, consistent with exemplary embodiments of the present disclosure;

FIG. 6A displays a cross-section an exemplary scenario, consistent with one or more exemplary embodiments of the present disclosure;

FIG. 6B displays a cross-section of another exemplary scenario in which an outer surface for an exemplary panel is formed at a bottom of the mold without forming folded edges, consistent with one or more exemplary embodiments of the present disclosure;

FIGS. 7A and 7B illustrate a multiple panel mold, consistent with one or more exemplary embodiments of the present disclosure;

FIG. 8A displays a cross-section of an exemplary scenario in which a plurality of panels are formed simultaneously utilizing a multiple-panel mold, wherein an outer surface for each respective panel is formed around a face area and folded edges of the panel, consistent with one or more exemplary embodiments of the present disclosure;

FIG. 8B displays a cross-section of another exemplary scenario in which a plurality of panels are formed simultaneously utilizing a multiple-panel mold, wherein an outer surface for each respective panel is formed only at a face area at a bottom of the mold without forming folded edges, consistent with one or more exemplary embodiments of the present disclosure;

FIGS. 9A, 9B, and 9C illustrate respective cross-section, top perspective, and bottom perspective views of an exemplary finalized panel, consistent with one or more exemplary embodiments of the present disclosure;

FIGS. 9D, 9E, and 9F illustrate respective cross-section, top perspective, and bottom perspective views of another exemplary finalized panel formed without folded edges, consistent with one or more exemplary embodiments of the present disclosure;

FIG. 10 illustrates exemplary an exemplary bladder valve panel, consistent with exemplary embodiments of the present disclosure;

FIGS. 11A and 11B illustrate two exemplary bladders, consistent with exemplary embodiments of the present disclosure;

FIGS. 12A-C illustrate cross-sections of exemplary scenarios with exemplary latex or adhesive applied to exemplary finalized panels, consistent with one or more exemplary embodiments of the present disclosure;

FIGS. 13A and 13B, illustrate exemplary stages of forming a pre-finalized balls, consistent with one or more exemplary embodiments of the present disclosure; and

FIGS. 14A-C illustrated exemplary panel shapes that may form an outer covering of an exemplary soccer ball, consistent with one or more exemplary embodiments of the present disclosure.

FIGS. 15A-C illustrated various indentation lines as illustrated on an outer layer, consistent with one or more exemplary embodiments of the present disclosure;

FIG. 16A illustrates three top views of respective pre-mold-cut outs, consistent with one or more exemplary embodiments of the present disclosure;

FIG. 16B illustrates perspective views of pre-mold-cut outs, consistent with one or more exemplary embodiments of the present disclosure;

FIG. 16C illustrates cross-section views of pre-mold-cut outs, consistent with one or more exemplary embodiments of the present disclosure;

FIGS. 17A and 17B illustrates cross-sections of exemplary mold in two exemplary scenarios, consistent with exemplary embodiments of the present disclosure;

FIG. 17C illustrates a panel formed by utilizing mold 600, consistent with one or more exemplary embodiments of the present disclosure

FIGS. 18A and 18B illustrate a multiple panel mold, consistent with one or more exemplary embodiments of the present disclosure;

FIGS. 19A and 19B illustrates cutouts that correspond to multiple panel shapes, consistent with one or more exemplary embodiments of the present disclosure; and

FIGS. 20A and 20B illustrate a multiple panel creating utilizing a multiple panel mold, consistent with one or more exemplary embodiments of the present disclosure.

### DETAILED DESCRIPTION

A sports ball is traditionally made up of two major components, a bladder for air and a cover of panels. Embodiments consistent with the present disclosure enhance the performance of a sports ball by providing a method and structure for efficiently utilizing manufacturing techniques for forming sports balls. Specifically, exemplary embodiments provide for utilizing unique methods to form unique structures which allow for efficient produced thermo-bonded balls, in terms of monetary and time resources.

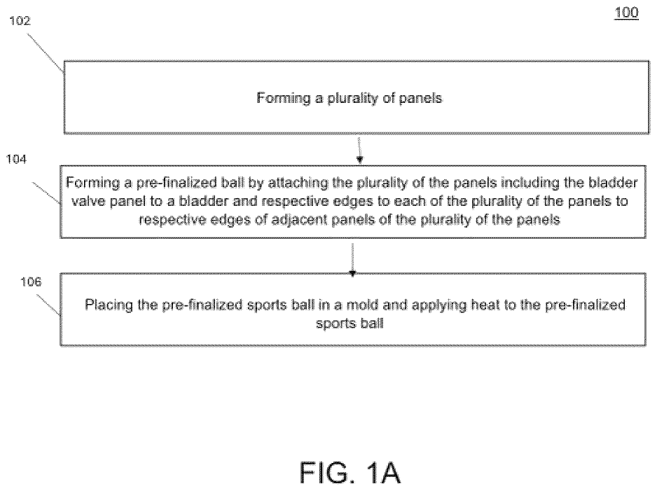

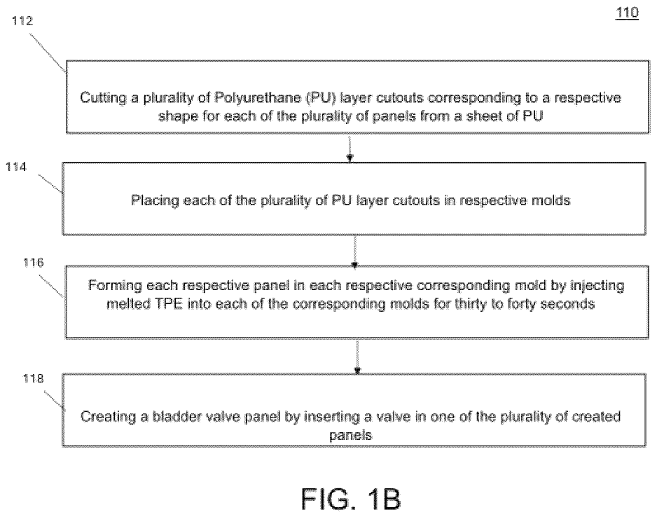

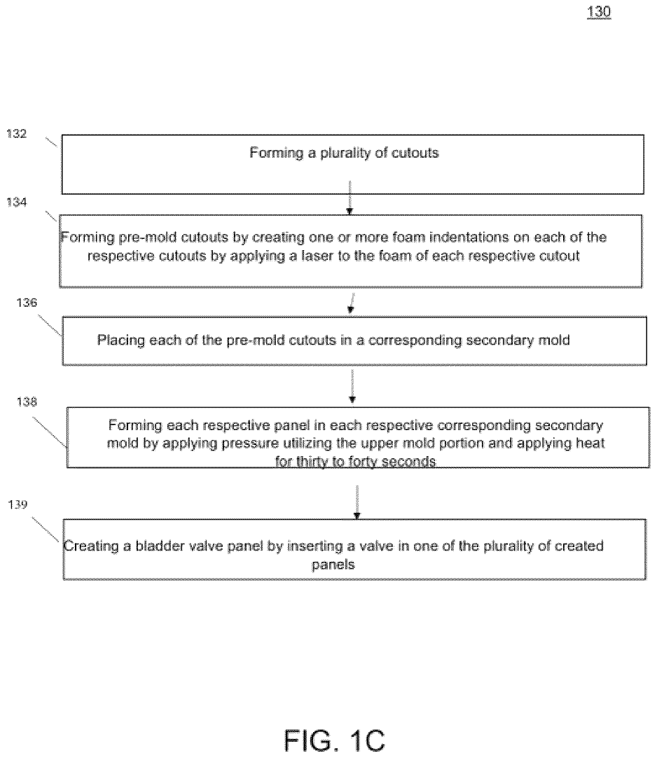

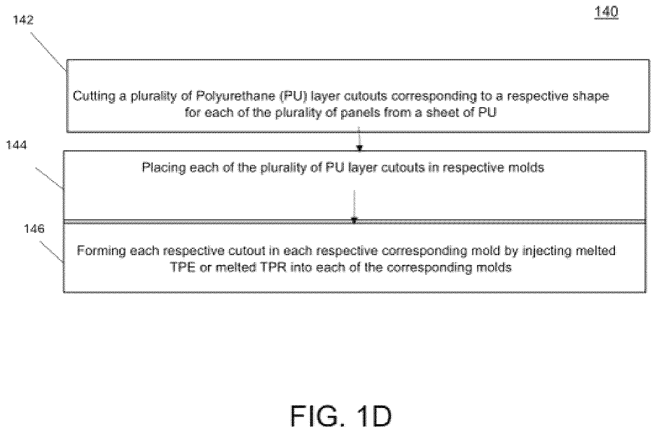

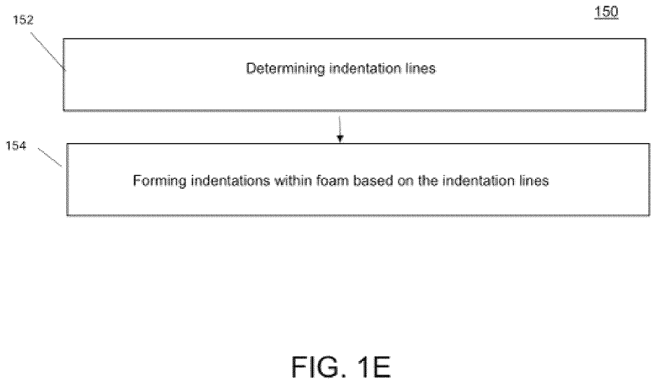

FIG. 1A illustrates an exemplary method 100 for manufacturing a sports ball, consistent with one or more exemplary embodiments of the present disclosure.

With further details, with respect to method 100, step 102 may comprise of forming a plurality of panels, consistent with one or more exemplary embodiments of the present disclosure.

In an Exemplary Embodiment, FIG. 1B illustrates flowchart 110 comprising details of step 102.

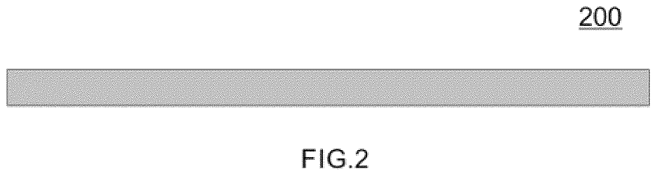

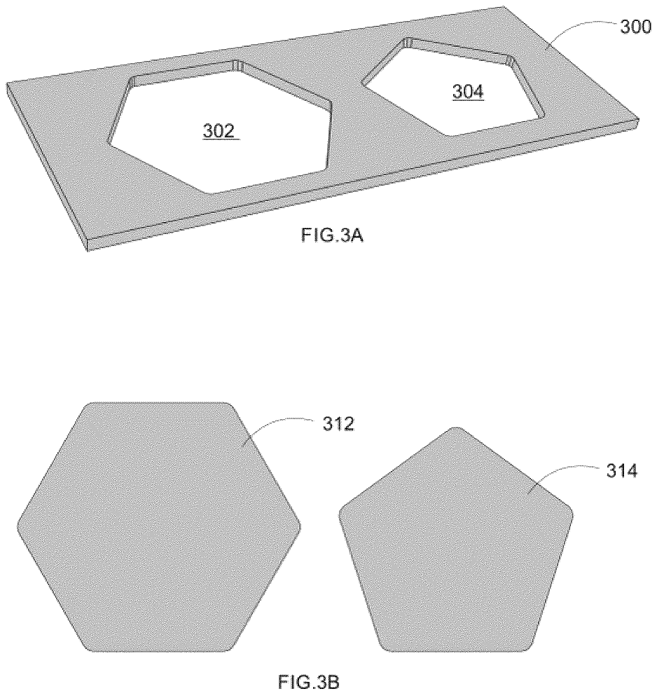

In an exemplary embodiment, step 112 may comprise of cutting a plurality of Polyurethane (PU) layer cutouts corresponding to a respective shape for each of the plurality of panels from a sheet of PU. In an exemplary embodiment, step 112 may be understood in the context of FIGS. 2, 3A, and 3B.

In an exemplary embodiment, FIG. 2 displays a PU Sheet 200. In an exemplary embodiment, PU Sheet 200 may have a thickness of 0.6 to 1.4 mm. In an exemplary embodiment, PU Sheet 200 may be a layer of Polyurethane (PU) or a similar synthetic material.

In an exemplary embodiment, FIGS. 3A and 3B are illustrations of an exemplary scenario for cutting out a plurality of PU layer cutouts, according to an embodiment of the present disclosure. As shown in FIG. 3A, required panel shapes (302 and 304) may be cut from layer 300 using conventional ball cutting knives. In an example embodiment, layer 300 may be an outer layer for panels of a sports ball similar to PU Sheet 200, consistent with exemplary embodiments of the present disclosure.

FIG. 3B illustrates exemplary cutouts 312 and 314 that may be cut from layer 300, for example from required panel shapes 302 and 304. In this exemplary scenario, cutouts 312 and 314 may represent a cutout of outer layer 300. In an exemplary embodiment, for each respective ball, there may be 4 to 20 cutouts which may all be transformed as explained in context of further steps below to collectively form the outside covering of a sports ball.

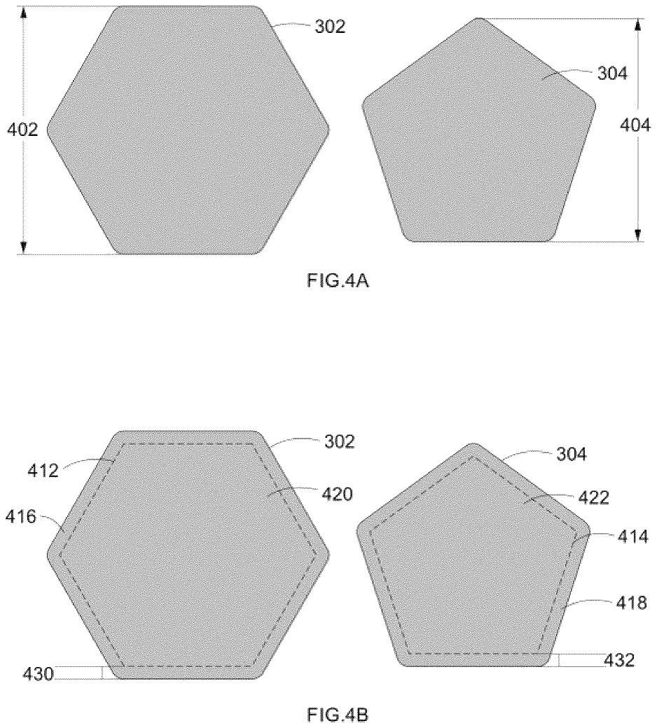

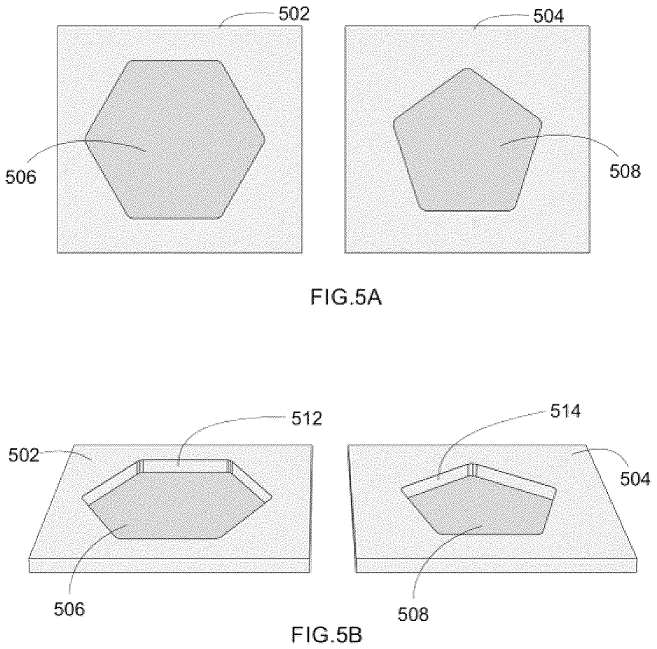

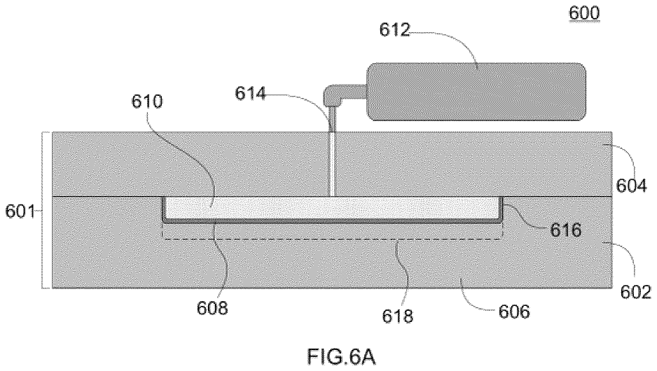

In an exemplary embodiment, step 114 may comprise of placing each of the plurality of PU layer cutouts in respective molds. In an exemplary embodiment, respective molds may have physical properties based on desired finalized shapes of finalized panels (as discussed in further detail below). Details of step 114 are explained in the context of FIGS. 4A, 4B, 5A, and 5B.

In an exemplary embodiment, FIG. 4A illustrates dimensions of cutouts 302 and 304 respectively. An exemplary end-to-end height 402 of cutout 302 may be 87 mm, while an exemplary end-to-end height 404 of cutout 304 may be 78.3 mm.

In an exemplary embodiment, FIG. 4B illustrates respective fold lines 412 and 414 of dimensions of cutouts 302 and 304 respectively. In an exemplary embodiment, respective fold lines 412 and 414 may be a distance of 4.5 mm away from exemplary outside edges of cutouts 302 and 304. In an exemplary embodiment, the distance is in direction of an exemplary biggest plane of a surface of an exemplary cutout. In cutout 302, based on fold lines 412, there may be an edge region 416. Similarly, in cutout 304, based on fold lines 414, there may be an edge region 418. In an exemplary embodiment, edge regions 416 and 418 may allow for panels to be attached to each other as will be explained in further detail below.

In an exemplary embodiment, FIGS. 5A and 5B illustrates exemplary molds 502 and 504 in top and perspective views respectively, consistent with exemplary embodiments of the present disclosure. Exemplary molds 502 and 504 may correspond to shape of a desired finalized panel (as discussed in further details below). In an exemplary embodiment, molds 502 and 504 may correspond to respective PUT cutouts 302 and 304. In an exemplary embodiment, finalized panel face mold parts 506 and 508 may correspond to respective areas (face areas 420 and 422) within respected fold lines 412 and 414, while finalized panel edge mold parts 512 and 514 may correspond to sections outside respected fold lines 412 and 414 (edge areas 416 and 418). As an example, when cutout 302 is placed within mold 502, face area 420 may be encompassed and be in direct contact with surface of finalized panel face mold part 506. Additionally, edge area 416 may be in direct contact with finalized panel edge mold part 512.

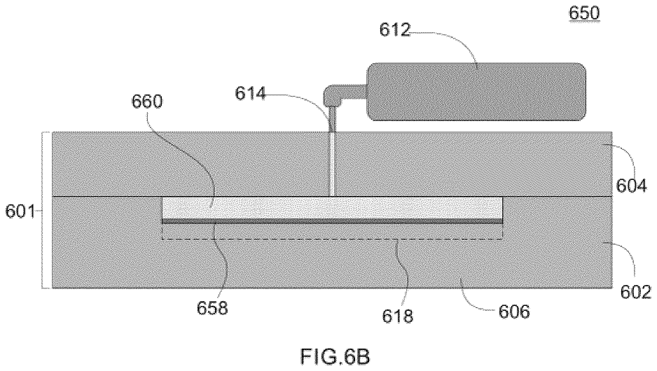

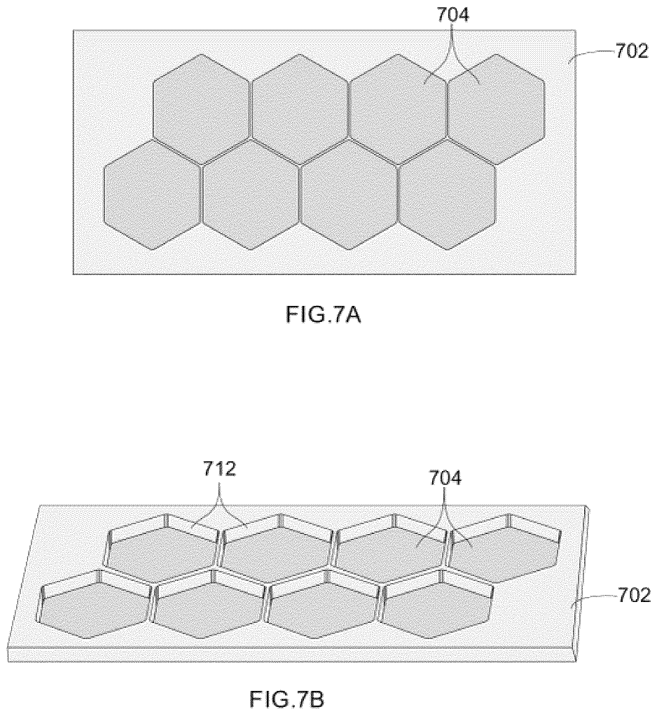

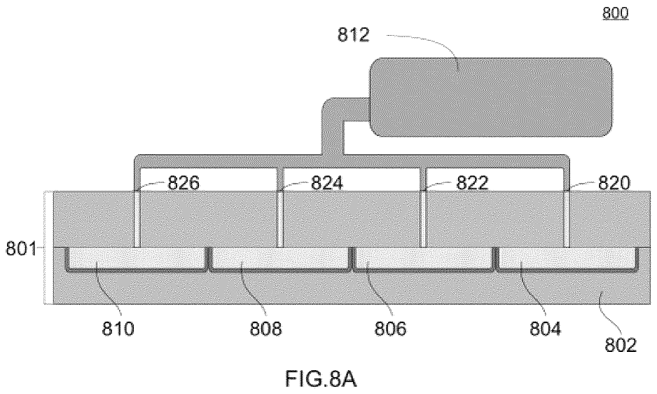

In an exemplary embodiment, step 116 may comprise of forming each respective panel in each respective corresponding mold by injecting melted TPE or TPR into each of the corresponding molds for thirty to forty seconds. In an exemplary embodiment, details of step 116 are explained in the context of FIGS. 6, 7A-B, 8 and 9A-C.

In an exemplary embodiment FIG. 6A displays a cross-section an exemplary scenario 600, consistent with one or more exemplary embodiments of the present disclosure. Exemplary scenario 600 may comprise of an exemplary mold 601 comprising bottom mold part 602 and top mold part 604. In an exemplary embodiment, bottom mold part 602 may be functionally similar to molds 502 and 504. In an exemplary embodiment, molds 502 and 504 would require corresponding parts on the other side which would seal the internal space. Furthermore, bottom mold part 602 may have a shape functionally or structurally corresponding to PU cutouts 302 and 304. Accordingly, folded-up part 616 may be similar to edge regions 416 and 418, and surface 618 may be similar to face areas 420 and 422. In an exemplary embodiment, an injector molder 612 connected through opening 614 where molding is injected. In an exemplary embodiment, an injector mold 612 may be a conventional injector which may be configured to inject melted mold into a space. In an exemplary embodiment, TPE granules or TPR granules may be placed within an injector mold 612 which may be melted by applying heat to TPE granules or TPR granules and the resulting melted materials may then be injected through opening 614 to fill up empty space between bottom mold part 602 and top mold part 604. In an exemplary embodiment, melted TPE or melted TPR may be formed by applying heat of 130 degrees to 200 degrees for between thirty to 60 seconds to exemplary TPE granules or TPR granules, for example, by exemplary molder 612. In an exemplary embodiment, mold 601 may be a cold mold. Accordingly, in an exemplary embodiment, after exemplary melted TPE or melted TPR is inserted into empty space, it may form foam in that space after a certain amount of time has passed and melted TPE or melted TPR is hardened to create foam. In an exemplary embodiment, foam 610 may be formed where melted TPE is inserted.

In an exemplary embodiment, FIGS. 7A and 7B illustrate a multiple panel mold, consistent with one or more exemplary embodiments of the present disclosure. In an exemplary embodiment, mold 702 may have a plurality of mold openings 704. In an exemplary embodiment, FIG. 7A illustrated a top view of mold 702 and FIG. 7B illustrated mold 702 from a perspective view. In an exemplary embodiment, each mold opening 704 may be functionally and structurally similar to finalized panel face mold parts 506 and 508. In an exemplary embodiment, mold openings 704 may be a plurality of openings but each mold may have any number of particular type of mold openings based on a require shaped of an exemplary finalized panel.

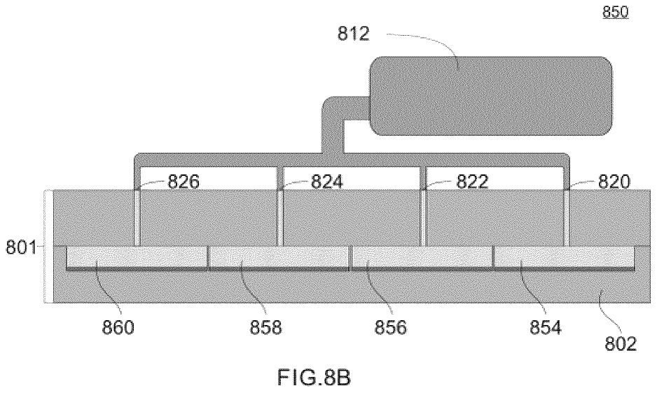

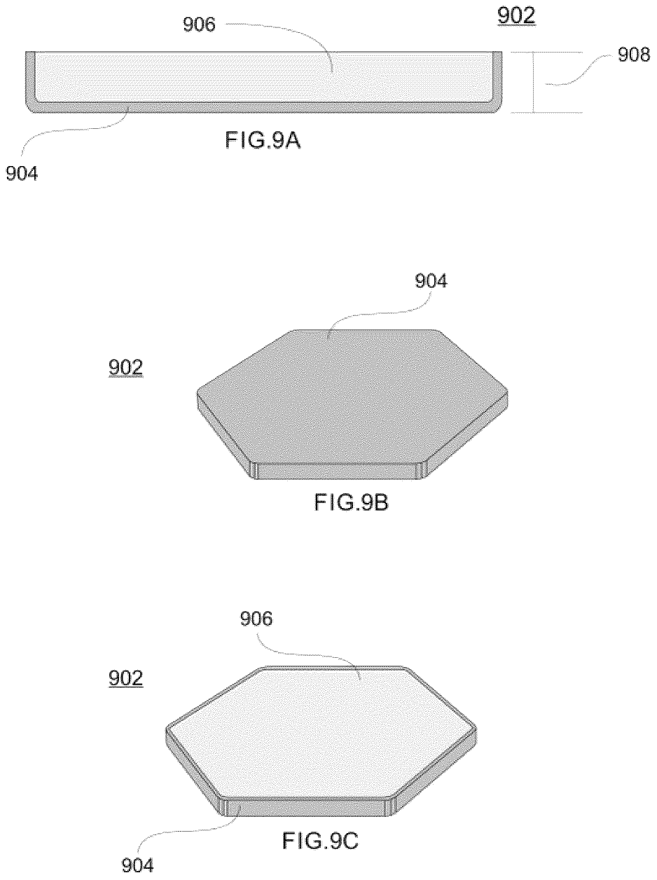

In an exemplary embodiment, FIG. 8A displays a cross-section an exemplary scenario 800, consistent with one or more exemplary embodiments of the present disclosure. Exemplary scenario 800 may comprise of mold 801 which (similar to mold 601) may comprise of bottom mold part 802 and top mold part 806. In an exemplary embodiment, difference between mold 801 and mold 601 may be that mold 601 may be geared towards a singular panel while mold 801 may allow for manufacturing of multiple finalized panels at the same time. In an exemplary embodiment, bottom mold part 802 may be functionally similar to mold 702. In an exemplary embodiment, mold 702 may require corresponding parts on the other side which would seal the internal space of mold openings 704. Accordingly, in context of FIG. 8, a plurality of panels may be formed at the same time. Therefore, in an exemplary embodiment, mold injector 812 (which may be functionally similar to mold injector 612) may inject melted TPE or melted TPR through multiple openings, such as openings 820, 822, 824, and 826, to form foams 804, 806, 808, and 810 respectively of exemplary finalized panels.

In an exemplary embodiment, FIG. 8B displays a cross-section of another exemplary scenario 850, consistent with one or more exemplary embodiments of the present disclosure. In an exemplary embodiment, scenario 850 may comprise of mold 801 (similar to scenario 800 of FIG. 8A) which may comprise of bottom mold part 802. In an exemplary embodiment, scenario 850 may differ from scenario 800 in that an outer surface for each respective panel may be formed only at a face area at a bottom of the mold without forming folded edges, similar to the relationship between FIG. 6A and FIG. 6B. Accordingly, in an exemplary embodiment, mold injector 812 (which may be functionally similar to mold injector 612) may inject melted TPE or melted TPR through multiple openings, such as openings 820, 822, 824, and 826, to form foams 854, 856, 858, and 860 respectively of exemplary finalized panels. In an exemplary embodiment, mold 801 in scenario 850 may correspond to PU layer cutouts formed in accordance with method 140 of FIG. 1D.

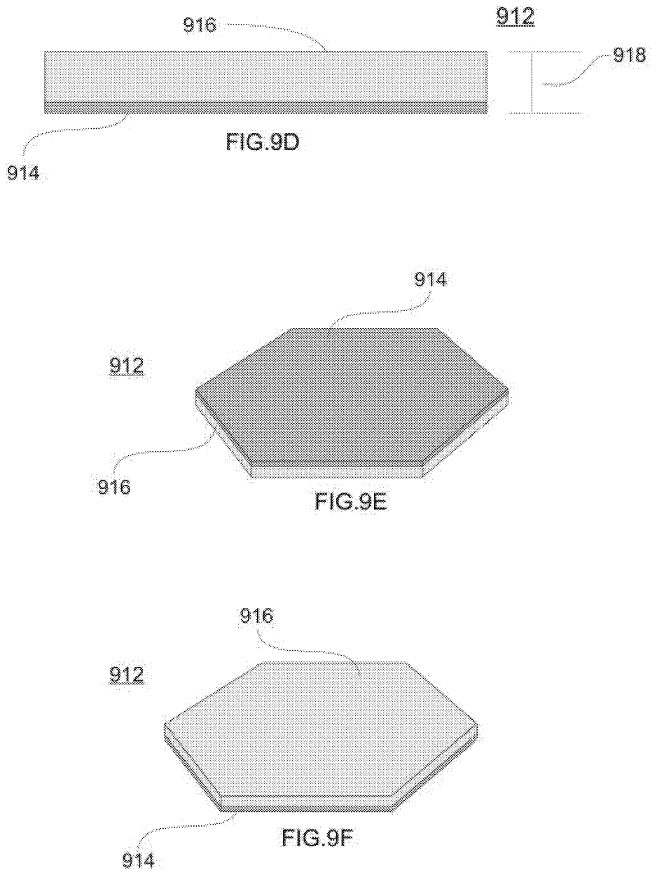

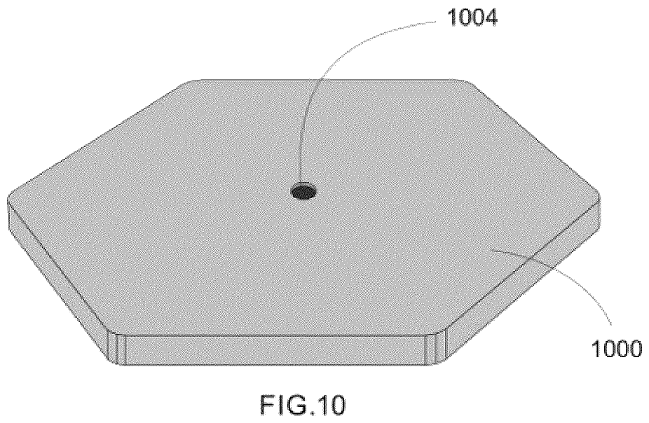

In an exemplary embodiment, FIGS. 9A-C illustrate respective cross section, top perspective, and a bottom perspective of an exemplary finalized panel, consistent with one or more exemplary embodiments of the present disclosure. In an exemplary embodiment, external surface 904 may refer to an outside surface formed for an exemplary finalized panel 902 that may be formed, for example, after step 116. In an exemplary embodiment, surface 904 may be formed based on exemplary PU cutouts 312 and 314. Accordingly, surface 904 is part of outside layer 908 which may be similar to PU cutouts 312 and 314. Accordingly, in an exemplary embodiment, finalized panel 902 may have a thickness 908 of 3 mm to 7 mm as displayed in FIG. 9A. Furthermore, in an exemplary 902 may have a thickness of 5.3 mm.

In an exemplary embodiment, FIG. 9C illustrates a bottom-view of embossed panel 902. In an exemplary embodiment, bottom-view of embossed panel 506 may clearly illustrate foam 906 formed based on exemplary melted TPE or melted TPR (cross-section of which is illustrated in FIG. 9A). In an exemplary embodiment, finalized panel 902 essentially comprises external surface 904 (comprising product an exemplary PU cutout) and foam 906.

In an exemplary embodiment, FIGS. 9D, 9E, and 9F illustrate respective cross-section, top perspective, and bottom perspective views of another exemplary finalized panel 912, consistent with one or more exemplary embodiments of the present disclosure. In an exemplary embodiment, finalized panel 912 may be similar to finalized panel 902 of FIGS. 9A, 9B, and 9C, but is formed without folded edges, similar to the relationship between FIG. 6A and FIG. 6B. In an exemplary embodiment, external surface 914 may refer to an outside surface formed for finalized panel 912 and may be similar to external surface 904 of finalized panel 902. In an exemplary embodiment, foam 916 may be similar to foam 906 of finalized panel 902. In an exemplary embodiment, finalized panel 912 may have a thickness 918 similar to thickness 908 of finalized panel 902. In an exemplary embodiment, finalized panel 912 may be formed, for example, in accordance with method 140 of FIG. 1D, including via a multiple-panel mold as illustrated in FIG. 8B.

In an exemplary embodiment, one of ordinary skill in the art will comprehend, that the elements illustrated within FIGS. 9B and 9C may not be drawn to scale. Instead, they have been illustrated in sizes that allow for easier comprehension. In an exemplary embodiment, while cross-section view of embossed panel 902 presented in FIG. 9A may appear flat, one of ordinary skill in the art may understand, that embosses panel 902 may have a curvature corresponding toto the shape of a ball in context of a surface area of finalized panel 902.

In an exemplary embodiment, step 118 may comprise of creating a bladder valve panel by inserting a valve in one of the plurality of created panels. In further detail, in an exemplary center of an exemplary panel, such as for example, finalized panel 902, a hole may be made into which an exemplary valve may be attached.

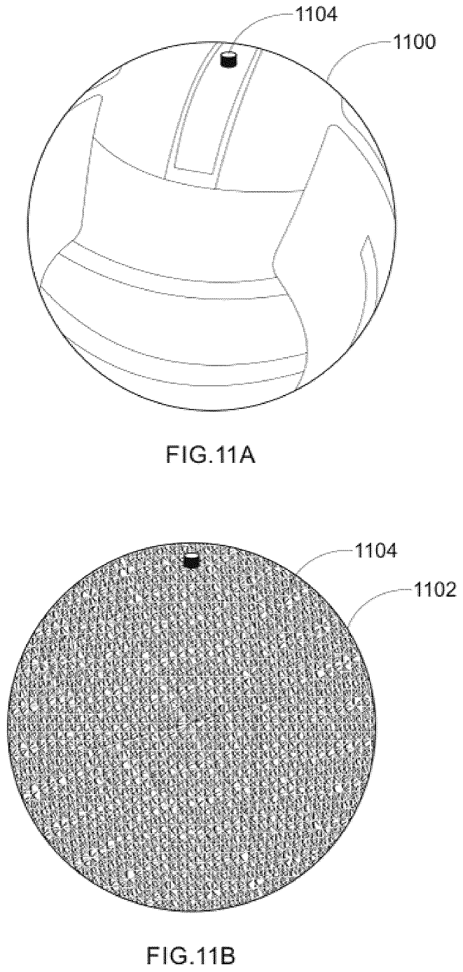

In an exemplary embodiment, FIG. 10 illustrates exemplary an exemplary bladder valve panel similar to as produced in context of step 104, consistent with exemplary embodiments of the present disclosure. A bladder valve panel may refer to an exemplary panel of a soccer ball that has a bladder attached to it and contains a valve for filling air into the bladder or for deflating the bladder. For example, an exemplary finalized panel 902. For example, FIG. 10, illustrates a bladder valve panel 1000, consistent with exemplary embodiments of the present disclosure. In an exemplary embodiment, a cutout of bladder valve panel 1000 may be similar to finalized panel 502. In further detail to step, 118, first, a cavity may be created in the middle of an exemplary display panel where an exemplary valve may be inserted. In an exemplary embodiment, conventional methods such as punching a hole by hand or by a machine one by one. Accordingly, cavity 1004 may be formed through which an exemplary valve (of an exemplary bladder). Therefore cavity 1004 may be located on bladder valve panel 1000.

In an exemplary embodiment, FIG. 1C illustrates another flowchart 130 comprising details of step 102. In an exemplary embodiment, step 132 may comprise of creating forming a plurality of cutouts. In an exemplary embodiment, FIG. 1D presents details of step 132, consistent with one or more exemplary embodiments of the present disclosure. In an exemplary embodiment, in method 140, steps 142, 144, and 146, may be similar to steps 112, 114, and 116, without taking into account fold lines corresponding to method 110. In detail, step 142 of method 140 may comprise of cutting a plurality of Polyurethane (PU) layer cutouts corresponding to a respective shape for each of the plurality of panels from a sheet of PU. In an exemplary embodiment, step 142 may be understood in the context of FIGS. 2, 3A, and 3B.

As discussed previously, in an exemplary embodiment, FIG. 2 displays a PU Sheet 200. Furthermore, in an exemplary embodiment, FIGS. 3A and 3B are illustrations of an exemplary scenario for cutting out a plurality of PU layer cutouts, according to an embodiment of the present disclosure. As shown in FIG. 3A, required panel shapes (302 and 304) may be cut from layer 300 using conventional ball cutting knives. In an example embodiment, layer 300 may be an outer layer for panels of a sports ball similar to PU Sheet 200, consistent with exemplary embodiments of the present disclosure.

FIG. 3B illustrates exemplary cutouts 312 and 314 that may be cut from layer 300, for example from required panel shapes 302 and 304. In this exemplary scenario, cutouts 312 and 314 may represent a cutout of outer layer 300. In an exemplary embodiment, for each respective ball, there may be 4 to 20 cutouts which may all be transformed as explained in context of further steps below to collectively form the outside covering of a sports ball.

In an exemplary embodiment, step 144 may comprise of placing each of the plurality of PU layer cutouts in respective molds. In an exemplary embodiment, respective molds may have physical properties based on desired finalized shapes of finalized panels (as discussed in further detail below). Details of step 144 are explained in the context of FIGS. 4A,5A, and 5B.

In an exemplary embodiment, FIG. 4A illustrates dimensions of cutouts 302 and 304 respectively. An exemplary end-to-end height 402 of cutout 302 may be 87 mm, while an exemplary end-to-end height 404 of cutout 304 may be 78.3 mm.

In an exemplary embodiment, FIGS. 5A and 5B illustrate exemplary molds 502 and 504 in top and perspective views respectively, consistent with exemplary embodiments of the present disclosure. Exemplary molds 502 and 504 may correspond to shape of a desired finalized panel (as discussed in further details below). In an exemplary embodiment, molds 502 and 504 may correspond to respective PUT cutouts 302 and 304.

In an exemplary embodiment, step 146 may comprise of forming each respective cutout in each respective corresponding mold by injecting melted TPE or melted TPR In an exemplary embodiment FIG. 6B displays a cross-section an exemplary scenario 650, consistent with one or more exemplary embodiments of the present disclosure. Exemplary scenario 650 may comprise of an exemplary mold 601 comprising bottom mold part 602 and top mold part 604. In an exemplary embodiment, bottom mold part 602 may be functionally similar to molds 502 and 504. In an exemplary embodiment, molds 502 and 504 would require corresponding parts on the other side which would seal the internal space. Furthermore, bottom mold part 602 may have a shape functionally or structurally corresponding to PU cutouts 302 and 304. Accordingly, and surface 658 may be similar to face areas 420 and 422. In an exemplary embodiment, an injector molder 612 connected through opening 614 where molding is injected. In an exemplary embodiment, an injector mold 612 may be a conventional injector which may be configured to inject melted mold into a space. In an exemplary embodiment, TPE granules or TPR granules may be placed within an injector mold 612 which may be melted by applying heat to TPE granules or TPR granules and the resulting melted materials may then be injected through opening 614 to fill up empty space between bottom mold part 602 and top mold part 604. In an exemplary embodiment, melted TPE may be formed by applying heat of 130 degrees to 200 degrees for between thirty to 60 seconds to exemplary TPE granules, for example, by exemplary molder 612. In an exemplary embodiment, mold 601 may be a cold mold. Accordingly, in an exemplary embodiment, after exemplary melted TPE or melted TPR is inserted into empty space, it may form foam in that space after a certain amount of time has passed and melted TPE or melted TPR is hardened to create foam. In an exemplary embodiment, foam 660 may be formed where melted TPE or melted TPR is inserted.

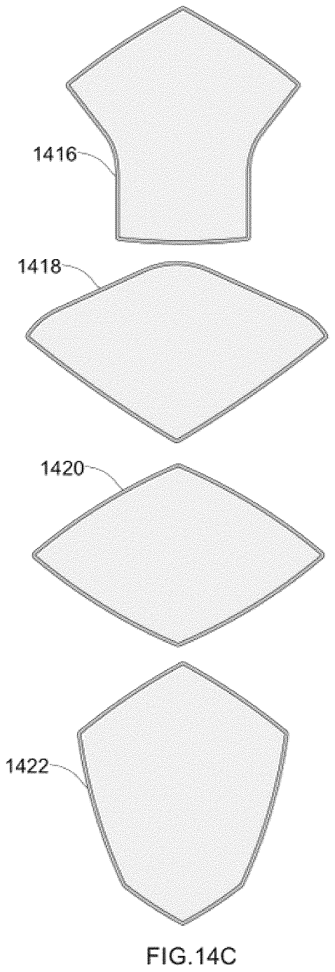

In an exemplary embodiment, method 130 may further comprise of step 134. In an exemplary embodiment, step 134 may comprise of forming pre-mold cutouts by creating one or more foam indentations on each of the respective cutouts by applying a laser to the foam of each respective cutout. In an exemplary embodiment, details of step 134 are provided in FIG. 1E comprising method 150. In an exemplary embodiment, details of method 150 are illustrated in further detail in combination with accompanying description of FIGS. 15A-C, 16A-C, and 17 A-C.

In an exemplary embodiment, step 152 may comprise of determining indentation lines. In an exemplary embodiment, indentation lines may comprise of exemplary imaginary (or real) lines on an exemplary surface of exemplary foam where indentations are to be created.

In an exemplary embodiment, FIGS. 15A-C illustrated various indentation lines as illustrated on an outer layer, consistent with one or more exemplary embodiments of the present disclosure. In an exemplary embodiment, FIG. 15A illustrates a singular indentation line 1510 on cutout 1500 (similar to exemplary cutout 302), while FIG. 15B illustrates respective indentation lines 1510 and 1512 respectively on cutout 1500. In an exemplary embodiment, respective indentation line 1510 may be a distance of 1.5 to 2 mm away from exemplary outside edges of cutout 302. In an exemplary embodiment, the distance may be in direction of an exemplary biggest plane of a surface of an exemplary cutout. In an exemplary embodiment, an indentation line 1512 may be a distance of 1.5 to 2 mm away from indentation line 1510 in a direction away from indentation line away from edges of cutout 302 (or towards the center of cutout 302). In an exemplary embodiment, there may be additional indentation lines, with each a distance from 1.5 to 2 mm from a closest indentation line. In an exemplary embodiment, FIG. 15C illustrates an additional indentation line 1514 in addition to indentation lines 1510 and 412. In an exemplary embodiment, there may be additional indentation lines included between indentation line 1512 and 1514, each with a distance of 1.5 to 2 mm. from a previous indentation line. In an exemplary embodiment, indentation line 1514 may be parallel to a respective edges of cutout 1500 but may be broken up so it may be present for less than two-thirds of a perimeter if it was constantly present.

In an exemplary embodiment, step 154 may comprise of forming indentations within foam based on the indentation lines. In detail, after indentation lines are determined/created, in an exemplary embodiment, an exemplary laser may be utilized to former indentations on an exemplary surface of exemplary foam based on exemplary indentation lines. In an exemplary embodiment, an exemplary laser may comprise of a laser produced by utilizing CO2. In an exemplary embodiment, laser may create an exemplary foam indentation on each of the respective cutouts.

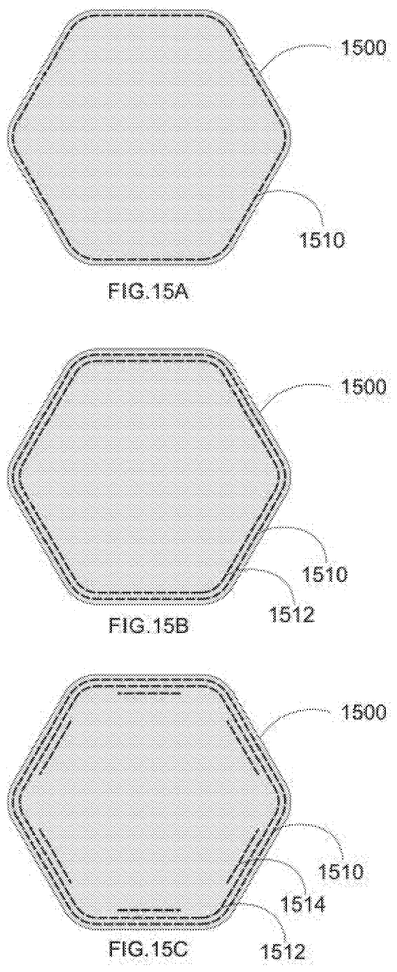

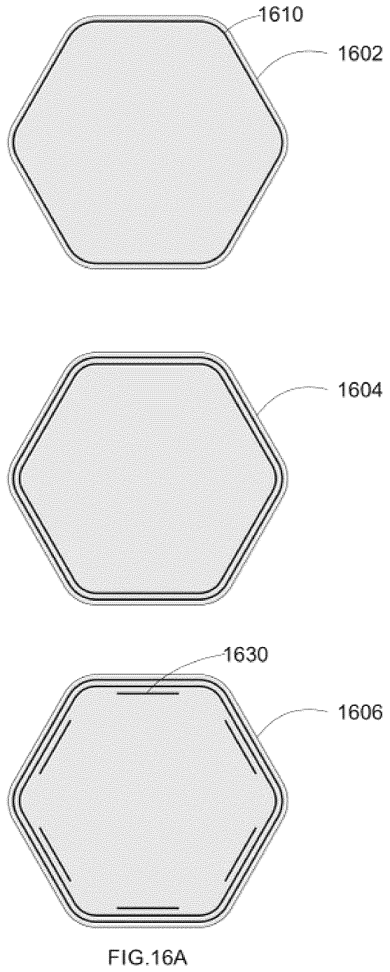

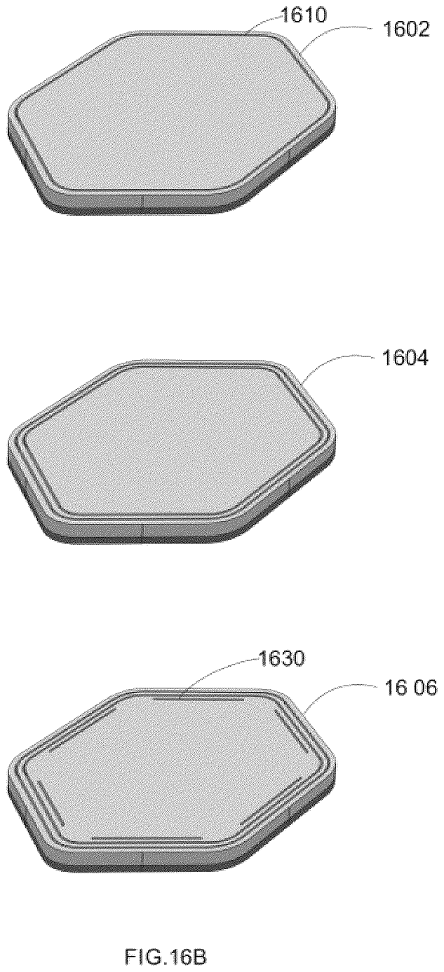

In an exemplary embodiment, FIG. 16A illustrates three top views of respective pre-mold-cut outs 1602, 1604, and 1606, FIG. 16B illustrates perspective views of pre-mold-cut outs 1602, 1604, and 1606, and FIG. 16C illustrates perspective views of pre-mold-cut outs 1602, 1604, and 1606, consistent with one or more exemplary embodiments of the present disclosure. In an exemplary embodiment, pre-mold cut out 1602 illustrates an exemplary scenario in which an indentation was formed at indentation line 1510, pre-mold cutout 1604 represents an exemplary scenario in which indentations were formed at indentation lines 1510 and 1512, while pre-mold cutout 506 represents an exemplary scenario in which indentations were formed at indentation lines 1510, 1512, and 1514.

In an exemplary embodiment, indentations illustrated throughout FIGS. 16A-C may have similar properties, but as an illustrative example, indentation 1610 from is described in further detail. In an exemplary embodiment, as illustrated in FIG. 16C, an end-to-end distance 1620 in a perspective view of an exemplary foam for an indentation 1610 may be 0.75 to 1.25 mm. Accordingly, in an exemplary embodiment, diameter of an exemplary laser utilized to make an exemplary indentation may be 0.75 to 1.25 mm (accordingly, an indentation may be made of a same size). In an exemplary embodiment, an indentation may have a depth 1622 of up to 3 mm, while the overall thickness 1624 of exemplary cutouts may be in a range of 5 mm to 6.5 mm. Accordingly, based on exemplary indentation lines, in an exemplary embodiment, an exemplary indentation may be present a certain distance from edges of a respective cutout through the periphery of exemplary cutout.

In an exemplary embodiment, as illustrated in pre-mold cutouts 1604 and 1606, there may be multiple indentations, for example, two to four additional indentations which may be a distance of 1.5 to 2 mm from another indentation. In an exemplary embodiment, an exemplary additional indentation may be present only for part of the indentation line, such as pre-mold cutout 1606, on an exemplary indentation may have a partial line. That is, indentation 1630 may occur with the same width, but on the periphery of exemplary cutout, it may occur for only part of an exemplary indentation line.

In an exemplary embodiment, method 130 may further comprise of step 118. In an exemplary embodiment, step 136 may comprise of placing each of the pre-molds cutouts in respective corresponding mold. In an exemplary embodiment, respective molds may have physical properties based on desired finalized shapes of finalized panels (as discussed in further detail below).

In an exemplary embodiment, method 130 may further comprise of step 138. In an exemplary embodiment, step 138 may comprise of forming each respective panel in each respective corresponding mold by applying pressure utilizing the upper mold portion and applying heat for thirty to forty seconds. In further detail, in an exemplary embodiment, an exemplary upper mold portion may apply downwards force while at the same time, heat may be applied for thirty to forty seconds comprising a temperature of 70 degrees Celsius or more.

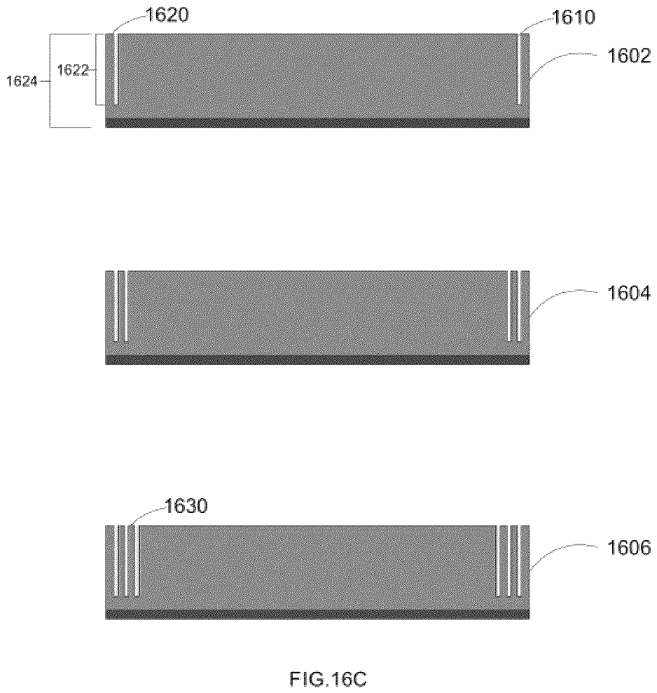

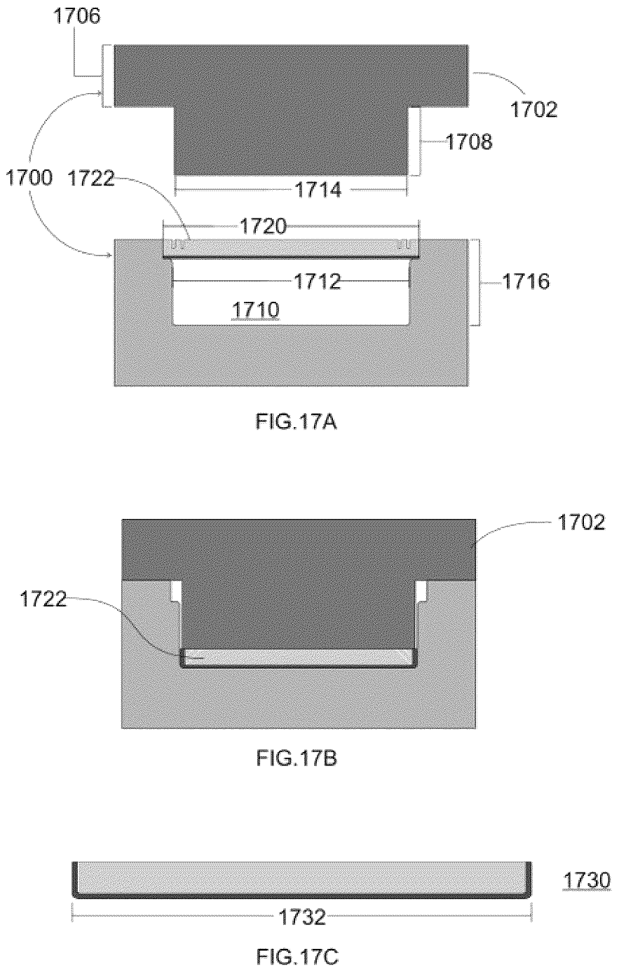

Details of steps 136 and 138 are explained in the context of FIGS. 17A and 17B. In an exemplary embodiment, FIGS. 17A and 17B illustrate cross-sections of exemplary mold 1700 in two exemplary scenarios, consistent with exemplary embodiments of the present disclosure. In an exemplary embodiment, FIG. 17A illustrates exemplary mold 1700 is illustrated in a pre-pressed state. In an exemplary embodiment, mold 1700 may comprise of upper mold portion 1702 and a lower mold portion 1704. In an exemplary embodiment, exemplary mold 1700 may correspond to shape of a desired finalized panel (as discussed in further details below). In an exemplary embodiment, mold 1700 may correspond to respective outer layer cutout 302. In an exemplary embodiment, upper mold portion 1702 may have a base part 1706 and a pressing part 1708. In an exemplary embodiment, pressing part 1708 may correspond to shape of a desired finalized panel and may also correspond to cavity 1710 within lower mold portion 1704. In an exemplary embodiment, end-to-end distance 1712 of cavity 1710 may be at least 0.5 mm more than end-to-end distance 1714 of pressing part 1708. In an exemplary embodiment, end-to-end distance 1712 of cavity 1610 may be 77.5 mm and end-to-end distance 1714 of pressing part 1708 may be 77 mm. This may allow pressing part 1708 to be fully enveloped within cavity 1712 while applying pressure to exemplary outer layer included within. In an exemplary embodiment, a top part 1720 of lower mold portion 1704, may have an end-to-end distance of 84.5 mm. Accordingly, an exemplary pre-mold panel 1722 with an end-to-end distance of 84.5 may be placed there. As illustrated, in an exemplary embodiment, pre-mold panel 1722 may have two respective indentations. In an exemplary embodiment, cavity 1710 may have a cavity depth 616 of 22.5 mm. In an exemplary embodiment, pressing part 1708 may have a height of 18 mm. Accordingly, when an exemplary outer layer with a thickness of 5 to 6.5 mm is present within cavity 1712, pressing part 1708 would be able to apply pressure to an exemplary outer layer.

In an exemplary embodiment, FIG. 17B illustrates exemplary mold 1700 in a second scenario, consistent with one or more exemplary embodiments of the present disclosure. Specifically, FIG. 17B illustrates mold 1700 in a pressed state. Specifically, upper mold portion 1702 applies pressure to pre-mold panel 1722 while it is contained within lower mold portion 1704. In an exemplary embodiment, as upper mold portion 1702 applies pressure to pre-mold panel, heat may be further applied by a heat source.

In an exemplary embodiment, FIG. 17C illustrates a panel formed by utilizing mold 1700, consistent with one or more exemplary embodiments of the present disclosure. In an exemplary embodiment, panel 1730 may have an end-to-end distance 632 or 78.5 mm. That is, cavity 1714 may have a lesser end-to-end distance than the finally produced panel because after being taken out of an exemplary mold, an exemplary panel may expand close to one millimeter.

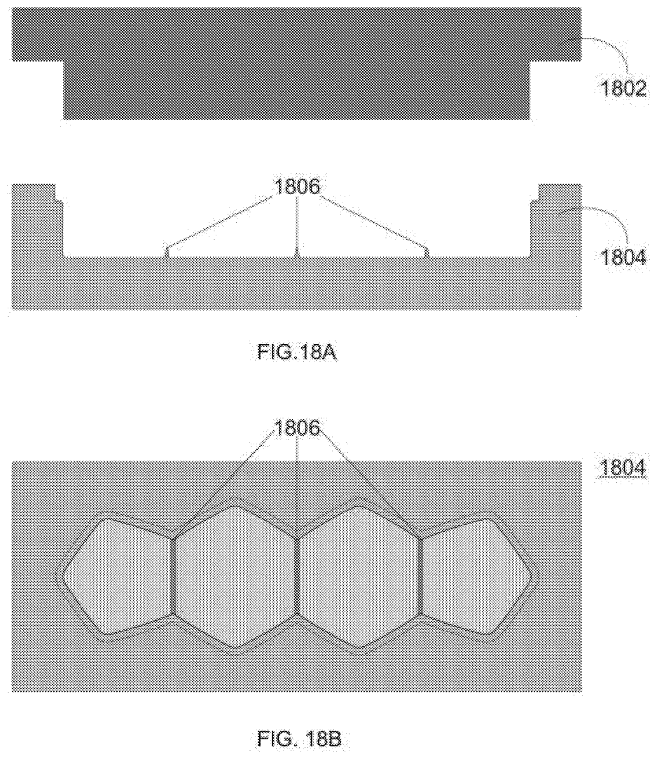

In an exemplary embodiment, FIGS. 18A and 18B and illustrate a multiple panel mold, consistent with one or more exemplary embodiments of the present disclosure. In an exemplary embodiment, mold 1800 may be a singular panel but may have an appearance of multiple panels. In an exemplary embodiment, FIG. 18A illustrated a side view of mold 1800. In an exemplary embodiment, mold 1800 may be similar to mold 1600, and may comprise of upper mold portion 1802 and a lower mold portion 1804 which may be functionally and structurally similar to upper mold portion 1702 and a lower mold portion 1704. In an exemplary embodiment, aesthetic panel bumps 1806 may be a plurality of embossing seam protrusions, that is, a part of an exemplary mold which is raised from a lower surface of an exemplary mold allowing for compression to be applied, allowing for exemplary seam lines to be created. In an exemplary embodiment, exemplary seam lines may allow for giving an impression that multiple panels are formed when, in fact, a long elongated singular panel may be present with one singular panel. In an exemplary embodiment, FIG. 18B illustrates a top view of lower mold portion 704.

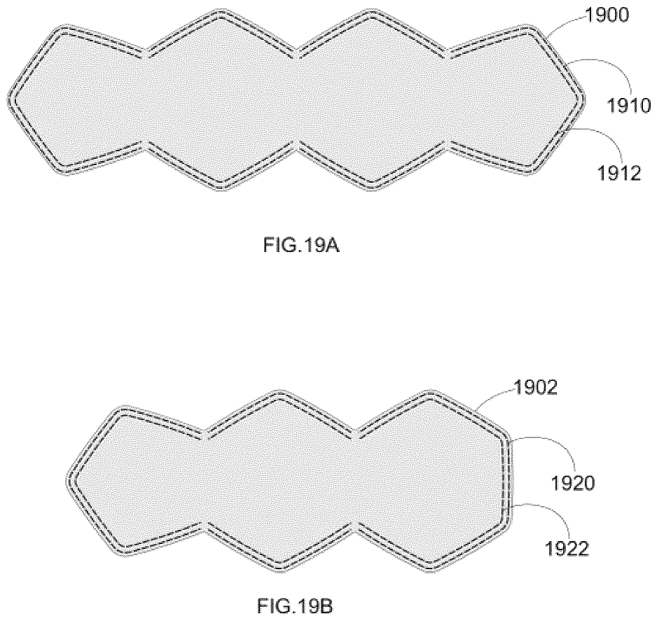

In an exemplary embodiment, FIGS. 19A and 19B illustrate cutouts 1900 and 1902 which may correspond to multiple panel shapes, consistent with one or more exemplary embodiments. In an exemplary embodiment, cutout 1900 may have indentation lines 1910 while cutout 1902 may have indentation lines 1920 and 1922. In an exemplary embodiment, there may be additional indentation lines as discussed above in context of FIG. 15 A-C.

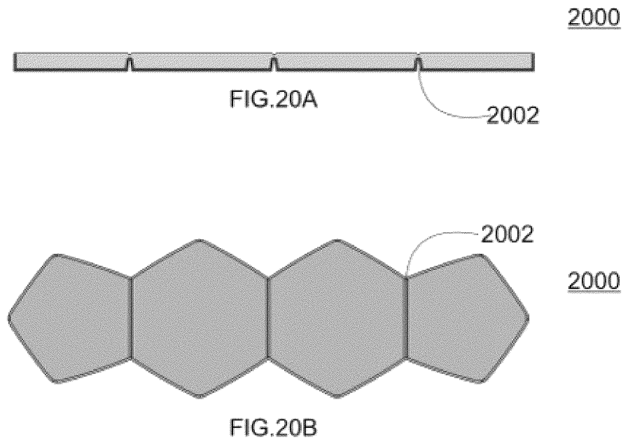

In an exemplary embodiment, FIGS. 20A and 20B illustrate an exemplary finalized panel 2000 which may be produced by utilizing mold 1800 on exemplary cutout 1900, consistent with one or more exemplary embodiments of the present disclosure. In an exemplary embodiment, finalized panel 2000 may have indentions 2002 that may be created based on indentation lines 1910.

In an exemplary embodiment, method 130 may further comprise of step 139. In an exemplary embodiment, step 139 may comprise of creating a bladder valve panel by inserting a valve in one of the plurality of created panels. In an exemplary embodiment, this may be done similarly to as done above with respect to method 1101, wherein a hole may be made into which an exemplary valve may be attached.

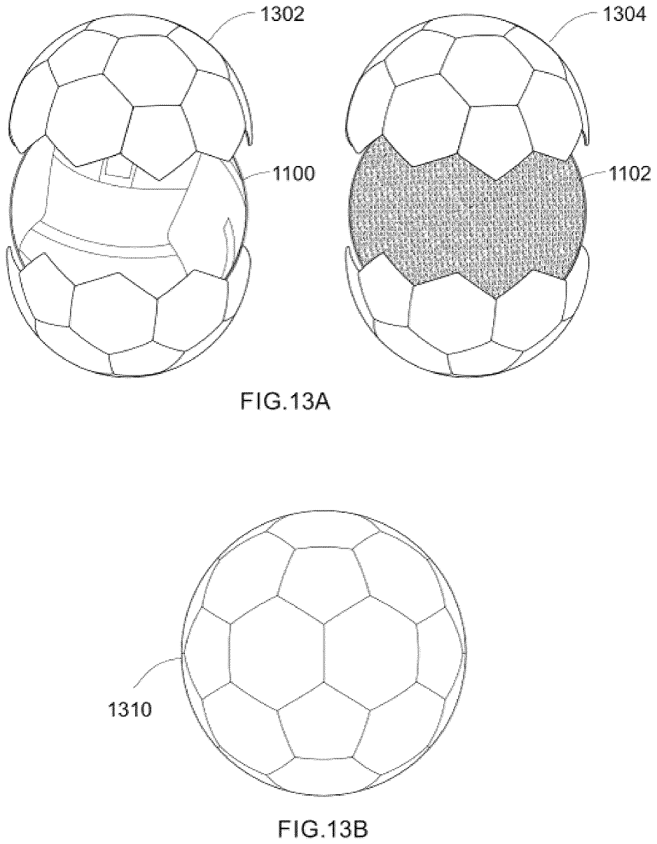

Now referring back to method 100, in an exemplary embodiment, method 100 may further comprise step 104 comprising forming a pre-finalized ball by attaching the plurality of the panels including the bladder valve panel to a bladder and respective edges to each of the plurality of the panels to respective edges of adjacent panels of the plurality of the panels. In an exemplary embodiment, further details with respect to step 104 may be clearly illustrated in combination with FIGS. 12A-14C.

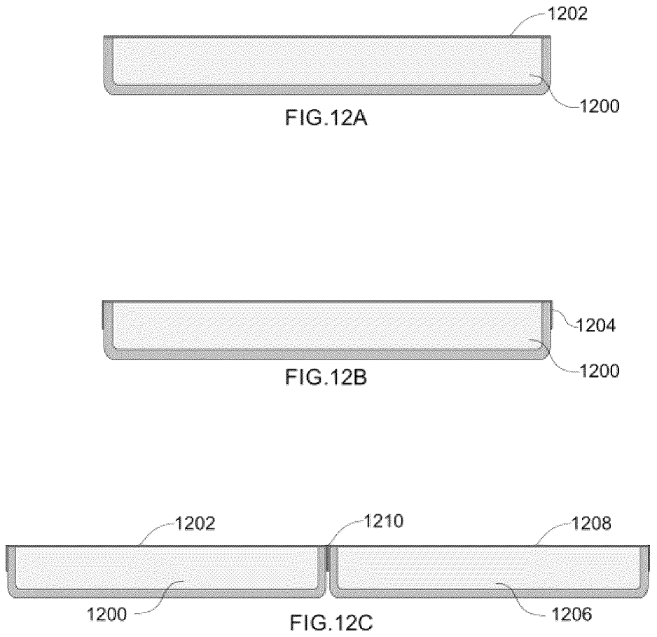

In an exemplary embodiment, FIGS. 11A and 11B illustrate two exemplary bladders 1100 and 1102, consistent with exemplary embodiments of the present disclosure. As illustrated, exemplary bladders 1100 and 1102 are both attached to exemplary valve 1104. In an exemplary embodiment, exemplary bladder valve panel as described in context of step 118 may be attached to this valve.

In an exemplary embodiment, bladder 1100 may comprise a molded rubber or butyl bladder or synthetic rubber that may be laminated with polyester or polyester cotton cloth strips. In an exemplary embodiment, bladder 1102 may comprise a molded rubber or butyl or synthetic rubber that may be wound with polyester or nylon threads. In an exemplary embodiments, additional bladders, with restricted circumference properties may be used. In exemplary embodiments, valve 1104 may be used for inflating or deflating bladders 1100 and 1102. Exemplary bladders aid in providing firmness and roundness to a soccer ball, in addition to serving as an exemplary base on top of which exemplary panels are attached.

Referring back to details of step 104, referring to attaching the plurality of the panels to a bladder may include attaching a set of panels to an exemplary bladder. In an exemplary embodiment, this may entail applying a latex or and adhesive all around on an outer surface of an exemplary bladder such as bladder 1100 and 1102. In an exemplary embodiment, an exemplary later may be applied on each finalized panel of the plurality of panels as well. FIGS. 12A-C illustrate cross-sections of exemplary scenarios with exemplary latex or adhesive applied to exemplary finalized panels, consistent with one or more exemplary embodiments of the present disclosure. In an exemplary embodiment, as illustrated in FIG. 12A, finalized panel 1200 may have adhesive or latex 1202 applied just on an exemplary bottoms surface (side with exemplary foam formed therein) which is meant to be attached to an exemplary bladder (such as bladders 1100 or 1102). In a second exemplary scenario as displayed in FIG. 12B, finalized panel 1200 may have adhesive or latex 1204 applied exemplary bottom surfaces (side of finalized panel with exemplary foam formed therein) and also at least half of the sides of finalized panels encompassing exemplary PU cutouts. In an exemplary embodiment, this may allow for two adjacent finalized panels to be connected with each other, in addition to being connected to an exemplary bladder. In an exemplary embodiment, FIG. 12C illustrated such an exemplary scenario, when finalized panel 1200 with adhesive or latex 1204, may be attached or connected to finalized panels 1206 with adhesive or latex 1208. In an exemplary embodiment, finalized panels 1200 and 1206 may be formed utilizing similar techniques and their edges may correspond to each other. Furthermore, latex and adhesives 120, 1204, and 1206 may be similar in terms of composition but may be applied as illustrated in the respective figures.

In an exemplary embodiment, bladder valve panel would be attached corresponding to an exemplary location of an exemplary valve on an exemplary bladder and remaining plurality of panels would be attached accordingly.

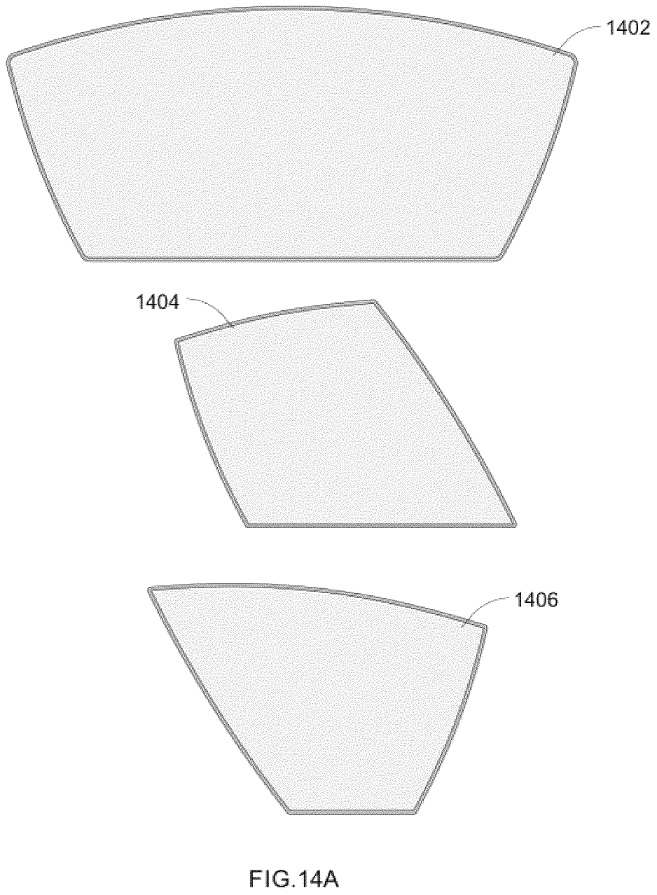

FIGS. 13A and 13B, illustrate exemplary stages of forming a pre-finalized balls, consistent with one or more exemplary embodiments of the present disclosure. In an exemplary embodiment, FIG. 13A illustrates plurality of panels 1302 and plurality of panels 1304 being placed respectively around bladders 1100 and 1102. In an exemplary embodiments, plurality of panels 1302 and 1304 may be exemplary panels formed utilizing step 102 of method 100. For simplicity, plurality of panels 1302 and 1302 are not illustrated displaying the valve panel but one of ordinary skill in the art would comprehend that one of the panels would be an exemplary bladder valve panel.

FIG. 13B displays a finalized ball 1310 that may comprise an internal exemplary bladder with exemplary plurality of panels attached thereon utilizing an exemplary latex or adhesive. In an exemplary embodiment, plurality of panels may also be attached to each other utilizing an exemplary latex or adhesive. In further detail, adhesives may be attached between respective edges of all the plurality of embossed panels. Therefore, in addition to the respective adhesives attaching the respective plurality of panels to an exemplary surface of an exemplary bladder, exemplary plurality of panels may also be attached to each other. In an exemplary embodiment, once all exemplary embossed panels for an exemplary sports ball are attached to an exemplary bladder utilizing an adhesive or glue, a bladder contained within a soccer ball may be completely filled with air.

In an exemplary embodiment, step 106 may comprise placing the pre-finalized sports ball in a mold and applying heat to the pre-finalized sports ball. In an exemplary embodiment, an exemplary pre-finalized sports ball may be placed in a heated molding machine (not shown) which is round in the finalized shape of a soccer ball. Heating under pressure of the inner cover of a molding machine may then be applied to the soccer ball for providing a permanent shape and thermo-bonding all of the elements contained within an exemplary mold for form an exemplary soccer ball.

In an exemplary embodiment, an exemplary soccer ball may be molded at 70 degrees Celsius for thirty seconds to sixty seconds. Accordingly, a total of sixty seconds of heat of 70 degrees Celsius may be applied to the soccer ball. Therefore, an exemplary the ball sets uniformly from outside through the pressure generated owing to the hot mold and inside due to the pressure from the bladder. In an exemplary embodiment, this may aid in providing a permanent shape to a sports ball and strengthen its bond on whole.

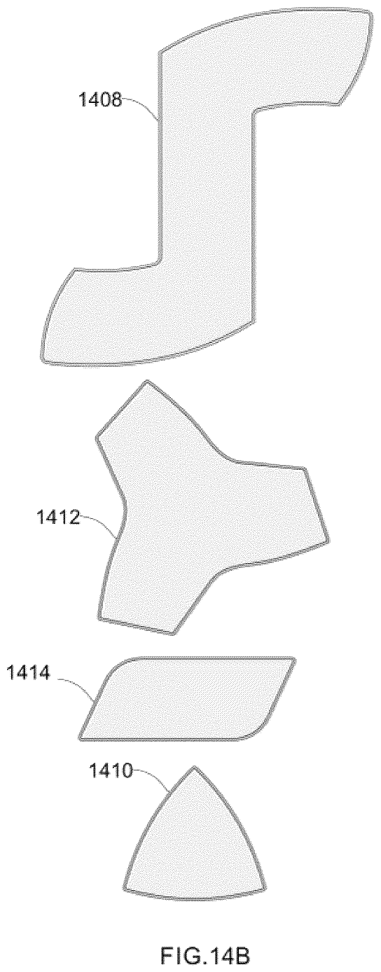

In an exemplary embodiment, one or ordinary skill in the art would comprehend, that an exemplary plurality of panels may not be restricted to shapes as illustrated in some exemplary embodiments, but any combination of individual panels which may form exemplary of plurality of panels which in combination can be attached to exemplary bladders to form a pre-finalized ball. FIGS. 14A-C illustrated exemplary panel shapes that may form an outer covering of an exemplary soccer ball, consistent with one or more exemplary embodiments of the present disclosure. For example, a plurality of exemplary panels with shapes of panels 1402, 1404, and 1406 as illustrated in FIG. 14A may form an exemplary outside covering of an exemplary soccer ball. Similarly, a plurality of exemplary panels with shapes of panels 1408, 14010, 1412, and 1414 as illustrated in FIG. 14B may form an exemplary outside covering of an exemplary soccer ball. Additionally, a plurality of exemplary panels with shapes of panels 1416, 1418, 1420, and 1422 as illustrated in FIG. 14C may form an exemplary outside covering of an exemplary soccer ball. In an exemplary embodiment, each exemplary panel displayed in FIGS. 14A-14C may be formed utilizing step 102 of method 100. Accordingly, an exemplary mold's shape would be similar to required panel shape but the principles as described in exemplary embodiments may remain consistent.

In any exemplary embodiments, any seams in an exemplary ball between exemplary embossed panels may be sealed by application of sealants before or after molding. Exemplary sealants may include polyurethane liquids among others.

In an exemplary embodiment, exemplary soccer balls manufactured according to exemplary methods aid in reducing manufacturing costs significantly, while at the same time, the ball rebounds, has water resistance/absorption, and has abrasion properties that are superior to the characteristics of current hand stitched and thermos-bonded balls. Furthermore, exemplary thermo-bonded balls may allow for intricate designs and graphics to be applied directly to the surface of the ball, resulting in visually appealing and professional appearance.

In an exemplary embodiment, exemplary thermos-bonded panels utilized to form a sport ball utilizing exemplary approaches may be applied in any types of balls that utilize panels and bladders, such as footballs, rugby balls, volleyballs, water polo balls, handballs etc.

What is claimed:

1. A manufacturing method of a sports ball, comprising the steps of:
forming a plurality of panels, comprising:
forming a plurality of cutouts, comprising:
cutting a plurality of Polyurethane (PU) layer cutouts corresponding to a respective shape for each of the plurality of panels from a sheet of PU, wherein the PU layer cutouts have an end-to-end length of 87 mm or 78.3 mm:
placing each of the plurality of PU layer cutouts in a corresponding mold, wherein a shape of the corresponding mold corresponds to a shape of a finalized cutouts;
forming each respective cutout in each respective corresponding mold by injecting melted TPE or Thermoplastic Rubber(TPR) into each of the corresponding molds for thirty to forty seconds;
forming pre-mold cutouts by creating one or more foam indentations on each respective cutout of the plurality of cutouts by removing a part of the foam of each respective cutout of the plurality of cutouts by applying a laser to the foam of each respective cutout;
forming each respective panel of the plurality of panels by:
placing each of the pre-mold cutouts in a corresponding secondary mold, wherein a shape of the corresponding secondary mold corresponds to a shape of a finalized panel, the corresponding secondary mold comprising of an upper mold portion and a lower mold portion, the lower mold portion comprising a cavity in a desired shape of a respective panel, the upper mold portion comprising a pressing part corresponding to shape of the cavity, wherein each of the pre-mold cutouts with an end-to-end length more than an end-to-end length of the pressing part;
creating a bladder valve panel by inserting a valve in one of the plurality of created panels;
forming a pre-finalized ball by attaching the plurality of the panels including the bladder valve panel to a bladder and respective edges to each of the plurality of the panels to respective edges of adjacent panels of the plurality of the panels; and
placing the pre-finalized sports ball in a ball mold and applying heat to the pre-finalized sports ball, wherein the applying heat to the pre-finalized sports ball comprises applying 70 degrees Celsius for thirty seconds to sixty seconds.

2. A manufacturing method of a sports ball, comprising the steps of:
forming a plurality of panels, comprising:
cutting a plurality of Polyurethane (PU) layer cutouts corresponding to a respective shape for each of the plurality of panels from a sheet of PU:
placing each of the plurality of PU layer cutouts in a corresponding mold;
forming each respective panel in each respective corresponding mold by injecting melted TPE into each of the corresponding molds for a pre-determined amount of time,
forming a plurality of panels, comprising:
forming a plurality of cutouts, comprising:
cutting a plurality of Polyurethane (PU) layer cutouts corresponding to a respective shape for each of the plurality of panels from a sheet of PU:
placing each of the plurality of PU layer cutouts in a corresponding mold;
forming each respective cutout in each respective corresponding mold by injecting melted TPE or TPR (Thermoplastic Rubber) into each of the corresponding molds for a pre-determined amount of time;
forming pre-mold cutouts by creating one or more foam indentations on each respective cutout of the plurality of cutouts by removing a part of the foam of each respective cutout of the plurality of cutouts by applying a laser to the foam of each respective cutout;
forming each respective panel of the plurality of panels by:
placing each of the pre-mold cutouts in a corresponding secondary mold, wherein a shape of the corresponding secondary mold corresponds to a shape of a finalized panel, the corresponding secondary mold comprising of an upper mold portion and a lower mold portion, the lower mold portion comprising a cavity in a desired shape of a respective panel, the upper mold portion comprising a pressing part corresponding to shape of the cavity, wherein each of the pre-mold cutouts with an end-to-end length more than an end-to-end length of the pressing part:
creating a bladder valve panel by inserting a valve in one of the plurality of created panels;
forming a pre-finalized ball by attaching the plurality of the panels including the bladder valve panel to a bladder and respective edges to each of the plurality of the panels to respective edges of adjacent panels of the plurality of the panels; and
placing the pre-finalized sports ball in a mold and applying heat to the pre-finalized sports ball.

3. The method of claim 2, wherein placing the each of the plurality of PU layer cutouts in the corresponding mold comprises a corresponding mold corresponding to a shape of a finalized panel.

4. The method of claim 3, wherein the PU layer cutouts have an end-to-end length of 87 mm or 78.3 mm.

5. The method of claim 5, wherein applying heat to the pre-finalized sports ball comprises applying 70 degrees Celsius for thirty seconds to sixty seconds.

6. The method of claim 5, wherein the pre-determined amount of time comprising thirty to forty seconds.

7. The method of claim 2, further comprising forming the bladder by wrapping a rubber bladder with a fabric or yarn.
